(19) United States
(12) Patent Application Publication
(10) Pub. No.: US 2004/0201488 A1
(43) Pub. Date: Oct. 14, 2004

(54) Gender-directed marketing in public restrooms

(76) Inventor: Rafael Elul, Atlanta, GA (US)

Correspondence Address: Rafael Elul, P.O. Box 603, Windermere, FL, 34786, US

(21) Appl. No.: 10/833,224

(22) Filed: Apr. 28, 2004

Related U.S. Application Data
(63) Continuation-in-part of application No. 10/008,169, filed on Nov. 5, 2001.

(51) Int. Cl. G08B 21/00

(52) U.S. Cl. 340/686.6; 705/14

(57) ABSTRACT

A method of gender-specific marketing by providing gender-directed audiovisual advertising to users of public restrooms, and optionally providing means for immediate ordering or on-the-spot purchase of the advertised items.

### RELATED APPLICATIONS

Continuation in Part of patent application Ser. No. 10/008,169 filed Nov. 5, 2001

### FEDERALLY SPONSORED

Not Applicable

### SUBMISSION ON A COMPACT DISK

Not Applicable

### BACKGROUND OF THE INVENTION

1. Field of the Invention

The present invention relates to the field of marketing in public restrooms.

Restroom design in private residences commonly includes a built-in bookshelf in consideration of the habit (reportedly more common among males) of reading while sitting on the toilet. Restrooms in public buildings do not have similar conveniences. Certain public restroom users bring to the restroom books, magazines, or newspapers, but the majority of users do not have reading material at hand. For that majority, the public restroom experience would be rendered significantly more enjoyable, if facilities were available in the restroom for display of text and/or images at an appropriate size and location for convenient viewing while seated on the toilet.

Displays of this type in public restrooms have also substantial economic value as a venue for advertising. From an advertiser's viewpoint, restroom displays have a number of attractive attributes: First, unlike standard television advertising, restroom displays literally have a “captive audience” for the duration of use of the restroom. Not only are users alone and absent of distractions, but “channel hopping”, excursions to the kitchen, etc., are not an option in that environment. Second, advertising in public restrooms lends itself to targeting by occupation, by gender, and in many cases also by income level. For example, restrooms in office buildings housing law offices, are primarily used by individuals in the legal professions, and advertising can be tailored to that specific audience. Similarly, staff restrooms in hospitals are used by physicians, nurses and other health professionals; restrooms in the symphony hall are used by individuals of well-defined cultural tastes, etc. Moreover, most public buildings include two separate sets of gender-specific restrooms, providing a ready venue for gender-oriented advertising as well as direct marketing. Male and female intimate products can be marketed very effectively in an environment from which the opposite gender is excluded. Other gender-specific needs can also be marketed advantageously in the restroom environment.

If properly structured, advertising in public restrooms can generate substantial revenue, while providing a strong incentive to provide public restrooms, and to keep such restrooms attractive, clean, and well-maintained. Accordingly, the goal of the present invention is to provide public restroom marketing systems, including advertising displays, and optionally also order-processing and order-delivery equipment.

2. Related Art

Several earlier inventions have used sound and/or television for entertainment, (e.g. Askaryar, U.S. Pat. No. 5,978,975, Sykes, U.S. Pat. No. 6,513,173), for assistance in daily schedule (e.g. Meine, U.S. Pat. No. 6,560,027), or as an aid in toilet hygiene (e.g. Kaufer, U.S. Pat. No. 5,748,096), in residential restrooms. Unlike these earlier inventions, the present invention uses video programming as a vehicle for advertising and marketing, and is primarily applicable to the public restroom environment.

Two earlier inventions address advertising in conjunction with urinal use in public restrooms (Muir, U.S. Pat. No. 6,385,796, Wang et al. U.S. Pat. No. 6,477,718). Unlike these earlier inventions, the present invention provides display advertising during use of the toilet. To make this possible, there is a significant physical difference between the present invention and prior art: The display in prior inventions was placed on or above the urinal. In the present invention, on the other hand, the display is placed opposite to the toilet basin, so as to be conveniently visible to an individual seated on the toilet. The present invention introduces also a dramatic increase in effectiveness as vehicle for advertising over prior inventions: (i) Human anatomy excludes females from use of urinals, so that the two prior inventions exclude more than half of the potential users of public restrooms. (ii) The time spent in use of a urinal typically is much briefer than the time spent in use of the toilet, increasing the effectiveness of the present invention for advertising. (iii) While the advertising provided by earlier inventions is restricted to the male gender, the present invention offers advertising for both sexes, and because separate public restrooms for males and females are commonly provided, the present invention can provide gender-based targeting of advertising that is not a feature of earlier inventions. (iv) Finally, the present invention provides means for on-the-spot marketing, a feature missing from prior art.

### SUMMARY OF THE INVENTION

The increased availability and falling price of video displays, whether CRT-based or flat-panel type, makes it economically feasible to provide displays in public restrooms.

Programming and maintenance are not costly. Moreover video displays offer essentially unlimited range of programming capabilities, making possible e.g. different programming for different segments of the day. Also, the growing availability of flat display panels, and of ultra-slim television sets, makes it practical for such panels and near-flat television sets to be incorporated in or above restroom doors or walls with only minimal change to the existing structures.

It is well known that advertising is most effective when the advertised items can be immediately purchased. In the present invention such purchase can be in a number of ways:

(i) from standard vending machines located in common areas adjacent to display-equipped restrooms, and carrying the advertised items;

(ii) from dispensing machines located in the restroom itself or in its immediate vicinity, where the customer pays for the item using a credit card reader installed inside the rest room;

(iii) through subsequent mail delivery, where the customer makes use of the same credit card reader to order the item while using the toilet.

### BRIEF DESCRIPTION OF THE DRAWINGS

FIG. 1. Typical layout of the restroom according to the present invention.

FIG. 2. Detail of restroom door, incorporating a marketing display.

FIG. 3. Flowchart summarizing the process of gender-directed marketing in public restrooms.

### DETAILED DESCRIPTION OF THE INVENTION

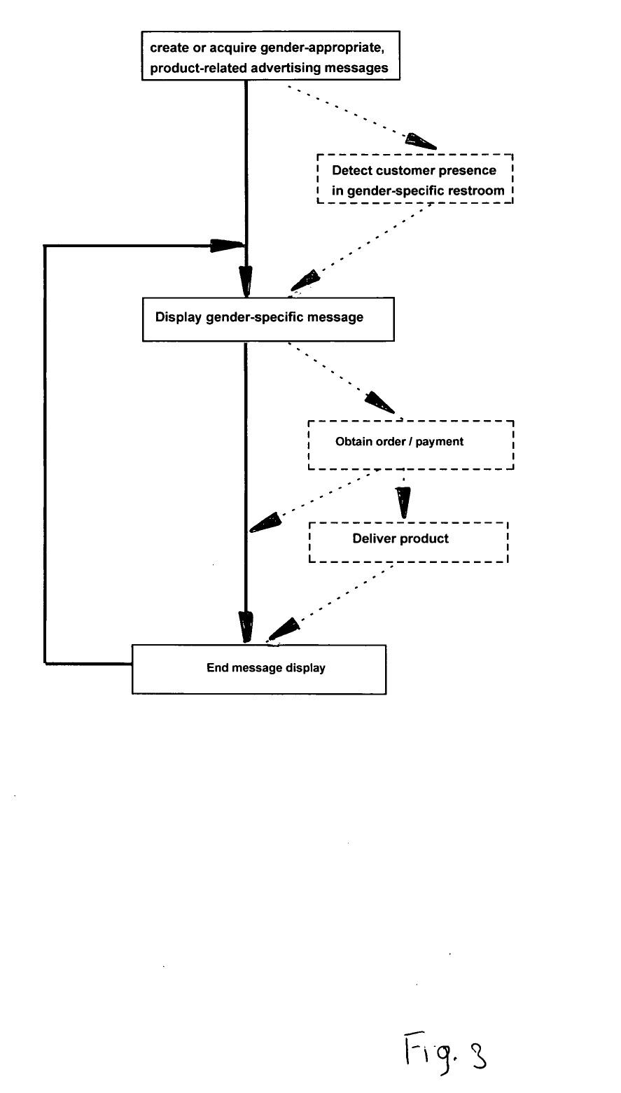

Details of some of the preferred embodiment of the present invention, can be better understood through inspection of the first two drawings. The flowchart of FIG. 3 summarizes the entire marketing process for that embodiment, as well as for the many other possible embodiments of the present invention.:

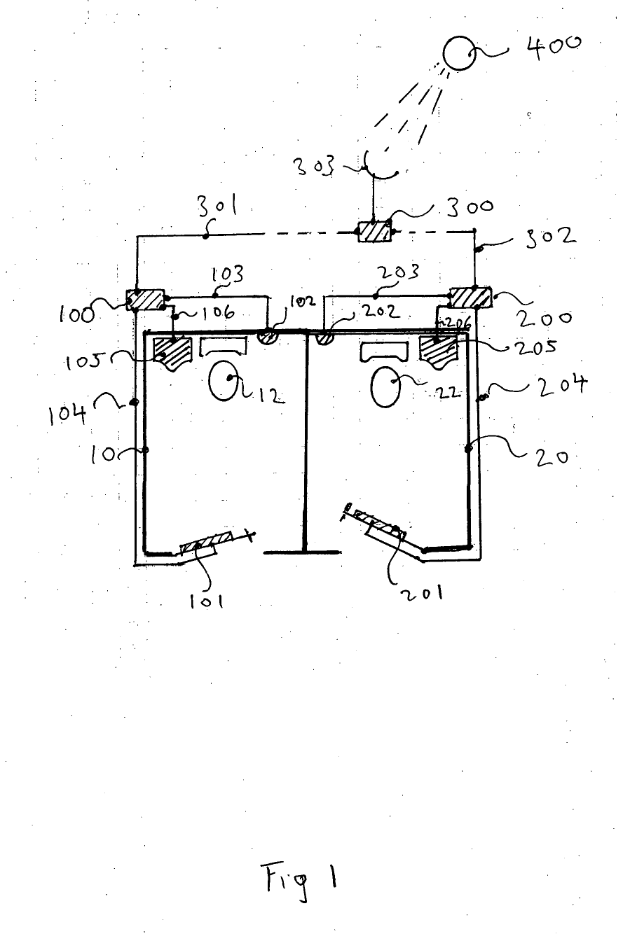

FIG. 1 presents the typical layout of a Women's restroom 10, with toilet 12, and a Men's restroom 20, with toilet 22. Display panels with integral sound 101, and 102, are set into the door of each restroom. Alternatively, these display panels can be set above the door, or elsewhere on the wall , so as to provide the best possible view while using toilets 12, 22, while at the same time minimizing the likelihood of damage. The display panels 101, 201, are connected by video cables 104, 204 to two programming units 100 and 200, respectively, which provide distinct marketing programming as appropriate for each gender. If desired, a sensor can optionally be provided in each restroom, to detect when that room is occupied. If present, these sensors, 102 and 202 respectively, are connected by wires, 103 and 203, to the respective programming units mentioned above, 100 and 200, making it possible for the marketing display to automatically restart each time the respective room is occupied by a new user. Additionally, the two programming units may be connected by cables 301, 302, to a program source 300, which may be a free-standing dual playback system, providing a specific advertising program for each gender. Alternatively specialized gender-specific programming may be provided remotely, e.g. by broadcast from satellite 400 and received by antenna 303, or via a ground connection to the internet, using standard communication techniques well known in the trade. Optionally, a credit card reader or similar point-of-sale device, 105 and 205, can be installed in rest rooms 10 and 20 respectively, and connected to programming units 100 and 200 by cables 106, 206. Provided that the programming units 100 and 200 are appropriately configured, these programming units can collect and process orders for advertised items, and deliver them from dispensing machines, using e-commerce methods well known in the trade.

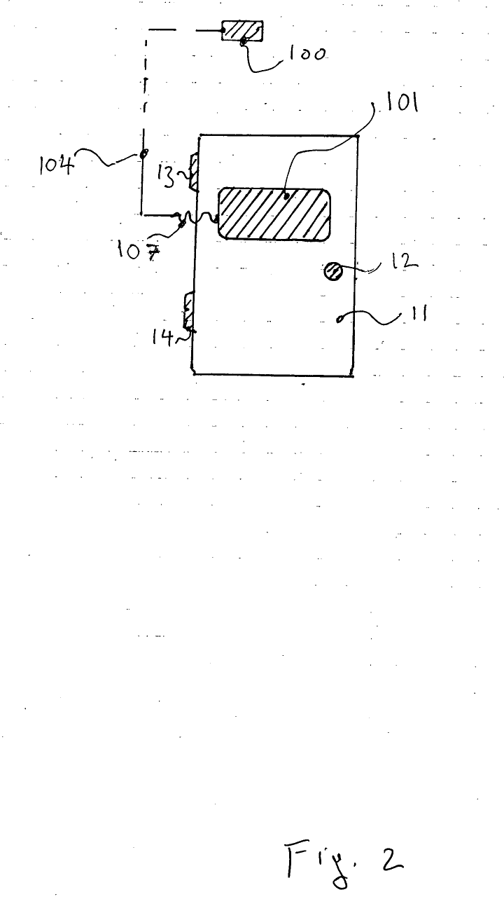

FIG. 2 presents the restroom door 11, with the inset display or near-flat television set with integral sound 101, readily visible to an individual seated on the toilet. The door 11 is attached to wall by hinges 13, 14, and closed or opened using knob 12. A cable 104 connected to the programming unit 100, transmits the necessary gender-specific program to the display panel 101 by means of a flexible link 107, placed on the hinge-side of the door.

FIG. 3 Summarizes the marketing system or process of the present invention. The three boxes with solid borders connected by solid lines represent the essential steps: preparation of gender-specific marketing messages, and display of these messages in the appropriate gender-specific restroom. As shown by the solid loop, the same message is displayed repetitively for subsequent users of the restroom. The three boxes on the right, surrounded by dashed lines, summarize further enhancements of the process: First, the presence of customer may be detected and utilized to start the advertising program. Second, orders may be collected and processed on immediate basis in restrooms equipped with a card reader or similar point-of-sale device, using e-commerce methods well known in the trade. Finally, the advertised product may be immediately delivered in restrooms equipped with dispensing machines, using methods of automated dispensing machines well known in the trade.

1. A process or method for gender-specific marketing in public rest rooms, grooming areas, powder rooms, and all other gender-segregated privacy enclaves in communal or public space, comprising the following steps:
(i) providing two or more gender-specific sources or programs of advertising of goods or services, such that for each gender there is available at least one source specific for that gender
(ii) displaying said advertising in, or substantially proximal to said gender-specific privacy areas, in such manner that the advertising program appropriate to each gender is clearly visible and/or audible in said privacy area of the corresponding gender
(iii) optionally providing means for immediate ordering and/or immediate purchase of all or some of said goods or services advertised to restroom users of each gender
whereby users of both genders of said privacy enclaves, are each presented with a distinct gender-specific advertising program appropriate to that same gender, and may have the opportunity of immediate purchase of the items advertised.
